(19) United States
(12) Patent Application Publication
(10) Pub. No.: US 2014/0337373 A1
(43) Pub. Date: Nov. 13, 2014

(54) SYSTEM FOR MANAGING GRAPH QUERIES ON RELATIONSHIPS AMONG ENTITIES USING GRAPH INDEX

(71) Applicant: Magnet Systems, Inc., Palo Alto, CA (US)

(72) Inventors: Magdi MORSI, San Jose, CA (US); Hanju KIM, Palo Alto, CA (US)

(21) Appl. No.: 13/889,155

(22) Filed: May 7, 2013

(51) Int. Cl. G06F 17/30

(52) U.S. Cl. CPC G06F 17/30424
USPC 707/769

(57) ABSTRACT

Systems and processes for managing graph queries on navigational relationships of database entities are described. A graph index may be used to store a class of navigational relationships to expand query capabilities and improve query efficiency of a traditional relational database. Entity relationships stored in the graph index may be dynamically defined and made accessible to query writers. In addition, users can specify particular entity attributes to be replicated in the graph index from the corresponding entities stored in the traditional relational database. Query performance may be improved by leveraging the graph index data and querying both the database and the graph index. Queries of the underlying database may be narrowed by first searching the graph index. Queries of the graph index may also be narrowed by first searching the underlying database. Historic query data may be stored and used to improve subsequent query execution plans.

### BACKGROUND

1. Field

The present disclosure relates to data storage and retrieval and, more specifically, to maintaining a graph index of navigational relationships among entities to improve database operations, such as queries.

2. Related Art

There are a variety of traditional approaches for indexing entity relationships in databases. For example, in some relational databases, each entity may be stored in a separate table that may include primary keys and foreign keys to capture entity associations. For certain relationships (e.g., one to many or 1:n), there may be an entry in the entity table defining the primary key attribute of one of the sides of the relationship. For other relationships (e.g., many to many or n:m), a separate additional table may be provided capturing just the relationships between entities.

In other approaches, view materialization may be used to store the results of a query to improve subsequent query performance. In Structured Query Language (“SQL”), expressions may be restricted to support incremental view updates, and the materialized view may contain both the underlying table and the updated index for efficient incremental update and efficient retrieval. Join index and index-only views may reduce this overhead by just maintaining an underlying index that is incrementally updated. For queries that are statically-defined (i.e., for a well-known access pattern), these mechanisms may be efficient.

Path indexing is another alternative to support efficient navigation for a prior access pattern. With typical path indexing, the access path between entities is statically-defined. An object model may also be used to capture relationships as special references among objects. Although this approach may enable efficient navigation, it is limited by the statically-defined navigation in the schema of the underlying classes/types. Accordingly, many of these traditional approaches are similar in that the allowed navigational paths are statically-defined by the underlying schema, and queries may thus be limited according to the statically-defined navigational constraints among related entities. Therefore, a system is desired for, among other things, managing graph queries on entity relationships that may be dynamically-defined and improving database operations generally through a mixture of storage concepts.

### SUMMARY

Systems and processes for managing graph queries on navigational relationships of database entities are described. A query relating to entities of a database may be received. A graph index may be searched based on the query. The graph index may include data relating to navigational relationships of entities of the database. A result of the query may be returned. The navigational relationship data may include statically-defined entity relationship data and dynamically-defined entity relationship data.

Searching the graph index may include navigating the graph index to retrieve navigational relationship data. The database may include an object relational database. The navigational relationship data may include a direction attribute that indicates relationship direction between database entities, a visibility attribute that indicates relationship visibility between entities, a scope attribute that designates valid entities on a side of an entity relationship, and/or a minimum attribute or a maximum attribute that constrains a number of relationships for an entity. The graph index may include at least one entity attribute replicated from an entity in the database.

### BRIEF DESCRIPTION OF THE FIGURES

The present application can be best understood by reference to the following description taken in conjunction with the accompanying drawing figures, in which like parts may be referred to by like numerals.

FIG. 1 illustrates an exemplary system for coordinating database operations across different storage types.

FIG. 2 illustrates an exemplary process for handling database operation requests.

FIG. 3A illustrates exemplary navigational relationships between entities.

FIG. 3B illustrates exemplary inverse (multi-sided) navigational relationships between entities.

FIG. 4 illustrates exemplary many-to-many navigational relationships between entities.

FIG. 5 illustrates an exemplary process for managing graph queries on navigational relationships of database entities.

FIG. 6 illustrates an exemplary computing system.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

In one embodiment, a graph database (i.e., a graph index) may be used to store a class of navigational relationships to augment traditional data platforms, such as relational or content-based stores, with navigational aspects. Entity relationships stored in the graph index may be dynamically defined, and the dynamically-added relationship data may be accessible to query writers. While some approaches may limit queries by requiring prior knowledge of the statically-defined entity relationships, a graph index with dynamically-defined entity relationships may allow queries on the entity relationships themselves without requiring knowledge of how entities may be related and without limiting the relationship data to statically-defined relationships in the underlying schema. For example, in some cases, entity relationships may be dynamically created (e.g., by a database user) where existing statically-defined relationships are insufficient to capture or express desired entity associations. Those dynamically added entity relationships may be stored in the graph index and may be used in a variety of ways to improve efficiency and enhance database capabilities. In queries, for example, dynamically-defined entity relationships may be used to express how entities are related, narrow the scope of a query, discover how entities that are structurally unrelated may be related in another way, or the like. A traditional database may thus be made more flexible and useful by storing dynamically-defined entity relationships in a graph index.

Moreover, users may be able to declaratively specify particular entity attributes to be indexed (e.g., replicated or duplicated) in the graph index to improve query efficiency and reduce access times. Attributes may also be stored on edges connecting graph nodes in a graph database, and these attributes may also be indexed in the graph index to achieve further improvements. Query performance may also be improved by leveraging the graph index data to improve queries of the underlying database or by leveraging the underlying database data to improve queries on the navigational relationship data stored in the graph index. These and other improvements will be discussed in further detail below.

A graph database or index, as discussed herein, may store a variety of information, including navigational relationship data corresponding to relationships among entities of a (logically) separate database. In one simplified example, a traditional relational database may store a collection of entities corresponding to users of a network. The users may access the network from a variety of different locations, and the traditional relational database may include a variety of information for each user, including each user's location. Data about relationships among the various network users may be stored in a graph database (or graph index). For example, the graph database may reflect that a user is a colleague to another user, that a user is supervised by another user, that a user supervises another user, or the like. A query may then use both the relational database and the graph database to identify a particular subset of network users. For example, a query may be generated to identify all network users who are related up to the third degree to users in Location X. In evaluating such a query, the traditional relational database may be queried to identify all users in Location X. The graph database (or graph index) may then be queried and used to navigate to and retrieve the users related up to the third degree to the Location X users identified from the traditional relational database query. Thus, the combination of both a traditional relational database and a graph database with navigational relationship data may provide enhanced query functionality and improved query efficiency.

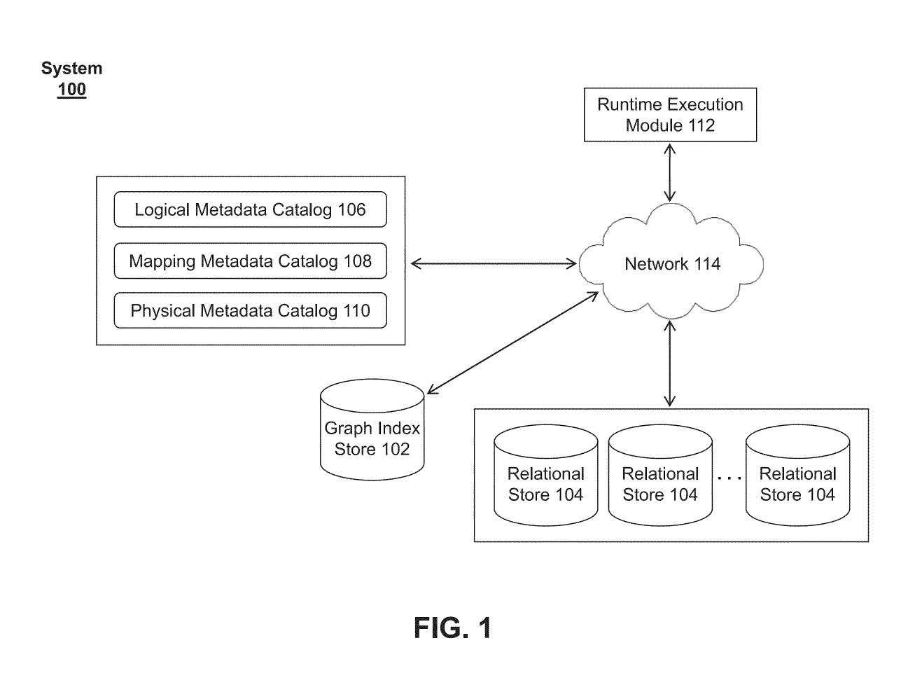

A variety of different storage architectures may be used in implementing the combination of a traditional relational store and a navigational store (e.g., graph database or graph index). In one embodiment, the storage architecture may include multiple data repositories with the same or differing capabilities. For example, FIG. 1 illustrates exemplary system 100 that may be used in implementing various embodiments discussed herein. System 100 may include graph index store 102, which may store navigational relationship data in a graph database format. The navigational relationship data stored in graph index store 102 may correspond to relationships among entities stored in any of relational stores 104. Relational stores 104 may include object-relational databases or any of a variety of other databases. Graph index store 102 and relational stores 104 may correspond to one or more physical storage devices, such as computer hard drives, network storage banks, Internet or cloud-based repositories, or the like. While graph index store 102 is illustrated separately from relational stores 104, it should be appreciated that the various stores may occupy the same storage device, a single store may be spread across multiple storage devices, or various databases may be stored in a variety of other combinations of storage devices.

System 100 may also include runtime execution module 112, which may coordinate database operations through network 114. Network 114 may include a local area network (LAN), wide area network (WAN), the Internet, wireless networks, or the like, and may include a variety of network hardware including servers, routers, and the like. Runtime execution module 112 may include a processor, a server, a computer workstation, or a variety of other hardware devices capable of coordinating database operations. In other embodiments, runtime execution module 112 may be incorporated into some or all of the storage devices corresponding to stores 102 and 104. Runtime execution module 112 may execute computer code for causing various database operations to be carried out including create, retrieve, update, delete, query, and the like. In some examples, a create operation may cause a new entry to be created in a database. A retrieve operation may refer to a simple operation to obtain data from a single logical collection (e.g., “get a list of users”). An update operation may modify an existing database entry. A delete operation may delete an existing database entry. A query operation may refer to a complex operation to gather a variety of information from one or more of the databases. For example, a query may span multiple collections and may include navigating one or more graph databases.

System 100 may also include metadata catalogs 106, 108, and 110 that runtime execution module 112 may use in coordinating database operations. In some embodiments, metadata catalogs 106, 108, and 110, although shown separately from stores 102 and 104, may be incorporated into some or all of stores 102 and 104. In other embodiments, metadata catalogs 106, 108, and 110 may be incorporated into runtime execution module 112 and its associated hardware. Logical metadata catalog 106 may include definition information supporting collections of entities and relationships among entities. For example, logical metadata catalog 106 may include entity definitions, collection definitions, and the like, including associated attributes, variables, constants, etc. Logical metadata catalog 106 may also define which operations (e.g., create, retrieve, update, delete, query, etc.) are supported for particular databases, collections, entities, and the like. In other words, logical metadata catalog 106 may indicate the capabilities and limitations of a particular database. For example, a particular database may include a static list of users and their associated attributes. Such a static list may be essentially read-only once instantiated from external data sources. As such, logical metadata catalog 106 may reflect that an update operation is not permitted for that particular database.

Physical metadata catalog 110 may include information relating to the physical storage of entities, collections, databases, and the like. Physical metadata catalog 110 may include the characteristics of physical stores, such as graph index store 102 and relational stores 104. For example, physical metadata catalog 110 may include the data format and connection capabilities of a particular physical store. Mapping metadata catalog 108 may include mapping information correlating logical entities and collections to corresponding physical stores. Such mapping information may reference relational stores 104, which may include any of a variety of database formats for persistent structured, unstructured, or semi-structured data.

In addition to metadata catalogs 106, 108, and 110, additional metadata may also be stored for use in database operations. For example, runtime execution module 112 may generate and use runtime metadata relating to the profiling of requests across different physical stores. To improve performance and/or system resource use, certain assumptions may be made for a particular database request. Profiling a request may include defining such assumptions for a particular request. For example, a request may be received to retrieve multiple documents. Runtime execution module 112 may—based on a profile of the retrieve request and the fact that multiple documents were requested simultaneously—assume that the triggering user wants to view the documents at a later time, not immediately. Based on this profiling, runtime execution module 112 may return placeholders from which the documents may be accessed later rather than performing the potentially time- and resource-intensive operations of retrieving each of the requested documents in their entirety.

In operation generally, runtime execution module 112 may translate requests for database operations and queries into specific operations and queries on the corresponding data stores. For example, a single logical database may be spread across multiple physical data stores. Runtime execution module 112 may, therefore, translate a request for an operation or query on the single logical database into corresponding operations or queries on the corresponding physical data stores. Likewise, when databases of different types are involved in a particular query or operation, runtime execution module 112 may translate the requested query or operation into corresponding operations or queries as appropriate for the different database types involved (e.g., with the corresponding instructions, operations, syntax, data format, etc.). In some embodiments, translating the logical-level requests into physical store-level operations may include accessing one or more of metadata catalogs 106, 108, and 110, as would be understood by one of ordinary skill in the art.

Runtime execution module 112 may also coordinate the order of execution of operations and queries on the corresponding physical stores. As discussed in further detail below, for example, queries on graph index store 102 and on relational stores 104 may be executed simultaneously or in different orders to achieve different performance goals. Runtime execution module 112 may thus select a particular order of physical store-level operations based on a particular query, a default execution order, a request profile, a particular performance goal, system balancing needs, or the like.

In response to operation and query requests from runtime execution module 112, physical stores 102 and 104 may return results in the form of a status, a result iterator, or the like. Runtime execution module 112 may use the returned results to build visible results for the requesting user, build to the next phase of database operations, generate another query, identify subsequent operation steps, or the like. In some instances, a physical store may be unable to complete an operation. In those cases, the physical store may back out or reverse any changes already made and return an error status indicating that the requested operation failed. Runtime execution module 112 may then request the operation again, return an error to the user, attempt a different operation, generate alternative operation steps, or the like.

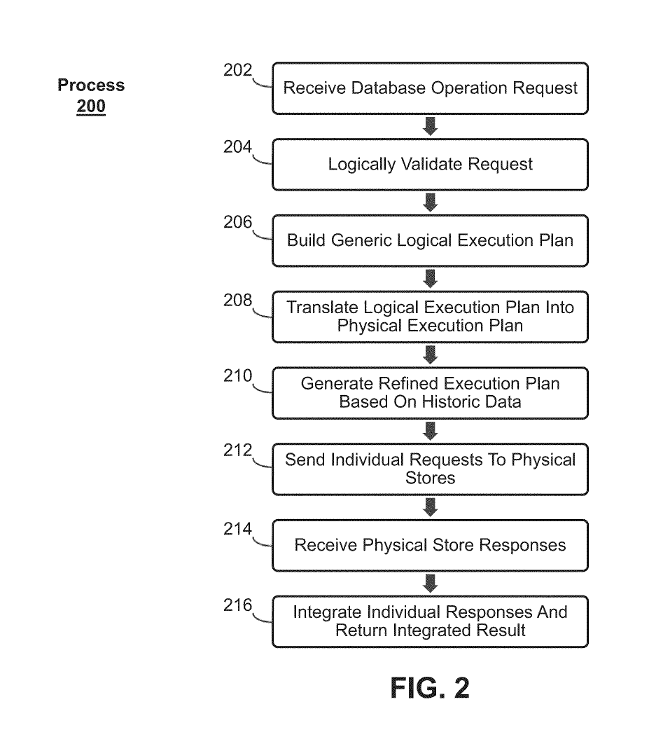

FIG. 2 illustrates exemplary process 200 for handling a requested database operation. Process 200 may, for example, be executed by runtime execution module 112 of FIG. 1. Communication to and from runtime execution module 112 may be carried out in a variety of ways, including via representational state transfer (“REST”) across distributed systems (e.g., a network, the Internet, etc.). At block 202, a database operation request may be received. A database operation may include creating a new entity, retrieving data, updating existing data, deleting data, executing a query, or the like. In some embodiments, when a request is received, additional context for the request may be added automatically to form a complete request. For example, referential names or identifiers may be correlated to unique identifiers for databases, entities, operations, or the like. Similarly, data relating to the requesting user may be used to form a complete request based on the user's attributes (e.g., identifying the hierarchical position or title of a user to interpret query terms or the like). A current workspace may also provide context for a particular request. Other contextual information may also be gathered and used to form a complete request including time, date, location, hardware, and the like, which may vary based on a particular implementation. In one embodiment, the context of a request may indicate that certain actions may improve performance, such as a pre-fetch of relevant data, a lazy load of time-expensive data, or the like.

At block 204, the request may be logically validated (e.g., based on the general collection logical capabilities). In one embodiment, a metadata catalog may be referenced to determine whether or not the requested database operation is valid for a particular database, collection, or entity. For example, as discussed above with reference to FIG. 1, runtime execution module 112 may access logical metadata catalog 106 to determine whether the requested operation is permitted. If a request is not logically valid (e.g., the requested operation cannot be carried out based on database restrictions or attributes), an error may be returned, the request may be denied, or the like. For example, a request to update a read-only collection may not be permitted, and the request may, therefore, be rejected.

At block 206, a generic logical execution plan may be built based on the requested operation. In one embodiment, building a generic logical execution plan may include determining a set of discrete operations, an order of operations, an order of accessing particular databases, or the like. The generic logical execution plan may also include logical metadata used to process the user request. The plan may be based, in part, on which logical collections are relevant. At block 208, the logical execution plan may be translated into a physical execution plan, which may include determining which physical stores to access and the like. For example, as discussed above with reference to FIG. 1, runtime execution module 112 may access one or both of mapping metadata catalog 108 and physical metadata catalog 110 in translating the logical execution plan into a physical execution plan. Operations may be mapped to multiple physical stores, such as graph index store 102 and relational stores 104. For example, as discussed in further detail below, a query may include a navigational filter on entity relationships, so the physical execution plan may include evaluating the navigational expression on graph index store 102, while other query expressions may be mapped to relational stores 104.

At block 210, a refined execution plan may be generated based, for example, on historic data. In one embodiment, runtime data from previous database operations may be used to improve the execution plan or otherwise implement plan variations. For example, if a previous database operation demonstrated that a particular order of operations was more efficient than another, the execution plan may be modified to follow the more efficient order of operations. Similarly, if results from a prior identical operation are still available, the results may be used instead of re-running the operation or to improve the new operation. In other embodiments, database operation optimizations may be implemented in the refined execution plan based on system resource availability, timing, or the like. In still other embodiments, other historic data may be used to improve the execution plan. The order of data movement between different physical stores may also be altered in the refined execution plan to achieve more efficient processing.

At block 212, individual requests may be sent to physical stores. In the example of FIG. 1, runtime execution module 112 may send individual requests to stores 102 and 104 to execute the database operations identified as part of the refined execution plan. The order of requests may follow the order defined in the refined execution plan. At block 214, responses from the physical stores may be received. Responses may include query results, status indicators, confirmations, errors, links, pointers, files, or the like. In some instances, the execution plan may be altered as results are received. For example, a lost connection or error result may trigger a compensating action between different stores. A compensating action may include backing out any completed operations when the execution plan is failing in one or more other requests. For example, a logical database may be stored on two different physical stores. Should the execution plan succeed in operations on one physical store but not the other (e.g., due to a lost connection, missing link, data corruption, etc.), the successful operations may be undone on the successful physical store and an overall error or failure result returned. In other instances, the execution plan may be altered based on received results to improve or refine later operations and the overall plan (e.g., narrow a subsequent query, eliminate a subsequent operation, etc.).

At block 216, the various individual physical store responses may be integrated, and the integrated result may be returned to the requester. In some instances, the result may include a message or notification (e.g., error, success, etc.). In other instances, the result may include entities, collections, attributes, data, or the like.

To support database operations (e.g., following process 200 using system 100), a graph index of navigational relationship data may be constructed for any of a variety of underlying databases, such as relational databases or content-based databases. The example of an object relational database will be used herein to illustrate how a graph index may, for example, improve query efficiency and provide enhanced query functionality, although one of skill in the art will recognize that the same concepts may be applied to other underlying databases and improve other database operations.

Following an object relational database standard (e.g., SQL:2003 Object-Relational Database Management System), a database may be formed by a collection of instances (extension) of different types (intention). Unlike typical SQL that includes table column definitions (i.e., schema definitions) and a collection of rows (i.e., instances of a type), an object relational database standard may define an entity type separately from a table or collection. For example, an entity type may be created named “person_t” that defines the type along with attributes of a person (e.g., first name, last name, phone number, email address, etc.). With the entity type and its attributes defined, multiple tables or collections of entities may be created using the same “person_t” type. For instance, the “person_t” type could be used to create a table of employees as well as a table of contacts.

The standard may also define the notion of a domain to identify a particular store to be used (e.g., a particular database), which may be a physical store in some instances (e.g., hard drive, workstation, network storage, cloud storage, etc.). In typical SQL, a domain may be analogous to a combination of a database instance and schema. For the object relational database standard, the domain may differentiate between like stores that include the same type. For example, contacts may be an example of a domain of a table of type “person_t” entities. In other examples, the domain may be a particular list of web-based contacts or a particular list of corporate directory contacts. The domain may be particularly important for integrating data from different data sources. For example, if Company A acquires Company B, the domain definition may be the mechanism used to integrate the enterprise resource planning systems of both companies. A collection may be a particular set of entities or instances of the type. For example, a collection may be a subset of the web-based contacts, a particular group of employees, all corporate directory contacts, or the like. By differentiating based on domain, different collections of the same entity type may be created and stored in different stores. In addition to type, domain, and collection, the database management system may use a unique system-generated identifier for each entity or instance of a store of data (e.g., a number, a name, an alphanumeric sequence, etc.). Thus, each instance may be identified by <Type, Domain, Collection, ID>.

In general, a relationship may be the mechanism used to relate entities across different collections (i.e., relate specific type instances across different collections). For example, a type called “employee_t” may have an attribute called “report_to” that is itself of a different type called “manager_t.” The relationship attribute “report_to” may thus identify the relationship between an employee and the employee's manager. Where multiple collections exist of the type “employee_t,” the scope of various attributes may be constrained. For example, in a database that includes a collection of Company A's employees and a collection of Company B's employees, an “employee_t” attribute such as “report_to” may be constrained to “manager_t” instances of a particular company. In other words, employees of Company A can only report to managers that belong to a Company A manager collection, and employees of Company B can only report to managers that belong to a Company B manager collection. Similarly, a relationship may be confined to a particular domain to ensure consistency. Such a constraint may also reflect the requirements of an underlying SQL, which may enforce referential constraints within a single store (i.e., database).

In one embodiment, the underlying database may support time-based attributes, time-based relationships, and time-based queries. For example, a database may include nodes connected by edges, and both the nodes and the edges may include time-based attributes that may be used in queries and may be used in generating a graph index. A detailed description of various features of time-based graph models is provided in U.S. patent application Ser. No. 13/838,143, entitled “TIME-BASED GRAPH DATA MODEL,” which is incorporated herein by reference in its entirety for all purposes.

In the context of an object relational database, an entity declaration may include a software module that defines the possible attributes of a particular entity (describes the object). For example, in constructing a database of products, an entity declaration may be crafted for an entity type called “product” that may be used to instantiate each product in the database. An entity declaration may include attributes for entity type, entity domain, entity collection, descriptive entity attributes, entity relationship attributes, and the like. As discussed above, the entity type, domain, collection, and attribute definitions may be similar to those of an object relational database standard. However, the relationship attributes may provide enhanced query functionality and efficiency, including support for dynamically-defined relationships. Such a declaration may also be referred to as a navigational relationship declaration indicating enhanced functionality, and, as discussed below, the navigational relationship data may extend beyond typical entity relationship data.

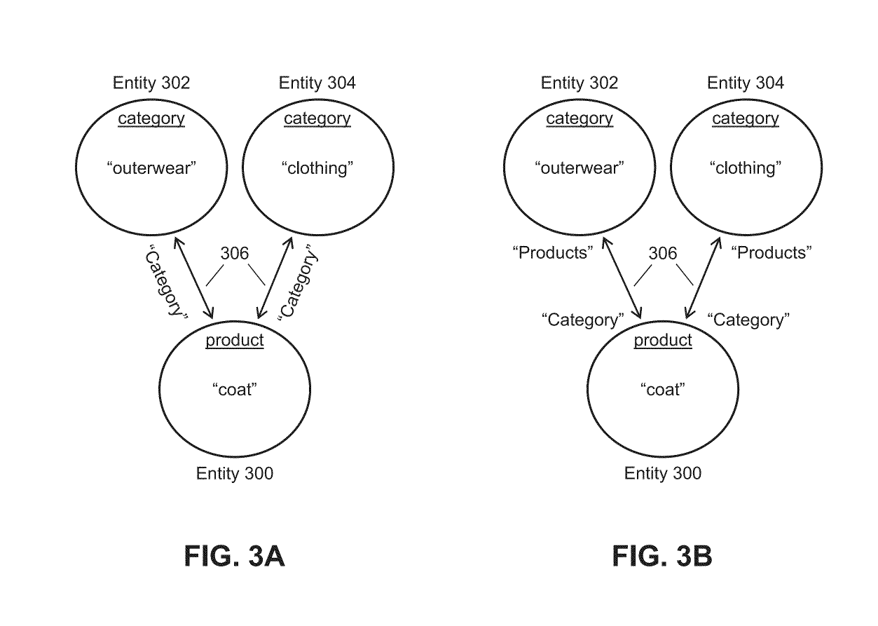

From the perspective of a given entity, a navigational relationship declaration may include a variety of attributes that define a particular entity relationship. Multiple relationships may be defined for a single entity, and a variety of different relationship attributes may be declared for each entity relationship. A navigational relationship declaration may include, for example, a name attribute describing the relationship. For example, as illustrated in FIG. 3A, entity 300 may be of type “product” and may include a name attribute of “coat.” Entity 300 may have two navigational relationships 306 with entities 302 and 304. Entities 302 and 304 may each be of type “category” with name attributes of “outerwear” and “clothing,” respectively. Navigational relationships 306 may have an associated name attribute, and such a name attribute may be the same or different for different navigational relationships. In the illustrated example, navigational relationships 306 each have a name attribute of “Category.” Thus, product entity “coat” may be related through navigational relationships “Category” to category entities “outerwear” and “clothing,” which may indicate that a coat may appear in both an outerwear category as well as a clothing category in a database of categorized products.

A navigational relationship may be statically defined or dynamically defined. A statically defined relationship may be included as part of an entity type definition. For example, a product type (e.g., “coat” entity 300 of FIG. 3A) may include in its entity definition a category relationship (e.g., “Category” relationships 306) to a category type (e.g., “outerwear” entity 302 and “clothing entity 304). In such an example, a product entity may be expected to have a relationship to at least one category entity as each product is likely to belong to at least one category, so the entity type definition may include a statically defined relationship correlating products to categories. In another example, a customer type may include a statically defined bid relationship to an item type in a database corresponding to customers bidding on items. In this additional example, the relationship may again be expected based on the logical relationship of the database entities, so the bid relationship between customer entities and item entities may be built into the entity definitions as a statically defined relationship. In yet another example, an employee type may include a statically defined supervisor relationship to a manager type in a database corresponding to managers and employees. In this example, the relationship may again be anticipated during database creation as managers are expected to have a supervisory relationship to employees, so the supervisor relationship may be incorporated into the entity definitions as a statically defined relationship. In other words, statically defined relationships may be incorporated into the database structure by including relationship attributes in the entity type definitions. However, statically defined relationships may be limited by what is known before instantiating the entities. In particular, relationships are likely only statically defined as part of an entity type definition when the relationships are anticipated based on the logical relationship of entities (e.g., when it is expected that products will be related to categories, that customers will be related to items, that managers will be related to employees, etc.).

In contrast, a dynamically defined relationship may exist where at least one side of the relationship is not defined. In one embodiment, a given entity may have a navigational relationship to any other entity, whether or not a statically defined or typical relationship is expected to exist between those two entities. In other words, dynamically defined navigational relationships may be generated to relate any two entities, as desired, without necessarily changing the entity type definitions of the entities to accommodate the relationship. For example, a navigational relationship may be defined relating to a grade, sentiment, or rating. User entities in a database may then be related via the navigational relationship to any other entity in the system, effectively providing a mechanism for user entities to express a grade, sentiment, or rating for any other entity in the system without necessarily re-defining entity type definitions. Other entities that may be related in such a way may include entities that may not typically be related to the user entities, such as document entities, product entities, workflow entities, or the like. For example, should a user express positive feedback for a particular workflow, a new relationship may be dynamically created to relate the corresponding user entity to the corresponding workflow entity to reflect the positive rating and store it for later access in order to, for example, suggest that workflow again, notify other users of a preference, or the like.

In another example, a new relationship may be dynamically defined to relate a subset of products for a special purpose that may not have been anticipated beforehand in a database of categorized products. An outfit, for example, may be created from a subset of clothing products to group them together for a catalog advertisement or store display (e.g., combining shoes, pants, a shirt, a coat, etc.). During database creation, such an outfit subset may not have been anticipated, and the database structure may not readily allow modifications to support such subsets. One or more dynamically defined relationships may then be generated to relate each of the outfit items as desired for such an unforeseen purpose. Similarly, in a database of managers and supervised employees, a new relationship may be dynamically defined to relate managers and employees who are assigned to a particular project. The database may, for example, be structured only to relate manager entities to the corresponding supervised employee entities, but a new project may make it desirable to have a new relationship correlating team members regardless of the supervisory relationships. New dynamically defined relationships may thus be added to relate project team members without being constrained by the statically defined supervisory relationships incorporated into the entity type definitions. In this manner, dynamically defined navigational relationships may provide an efficient mechanism for relating entities and relaying useful information about the relationships among entities, even where the relationship is atypical and not built into the database structure at the creation of the database.

A navigational relationship declaration may also include a navigational attribute. The navigational attribute may indicate whether or not the relationship may be used for queries, may be part of a query result set, may be navigated from one entity to another (i.e., navigable), may be dynamically-defined, or the like, which may differentiate a navigational relationship from a typical entity relationship without such enhanced features. In the example illustrated in FIG. 3A, navigational relationships 306 may both be navigable (as indicated by the double-sided arrow) both from entity 300 to entities 302 and 304 and from entities 302 and 304 to entity 300. In some embodiments, the navigational attribute may be set to either true or false, and the default value may be false for embodiments where typical relationships are not navigable. For example, the following computer code shows an exemplary navigational relationship declaration with an instance name attribute of “Category” and a navigational attribute set to true.

@RelationshipDefinition(ownership = false, instanceName =

“Category”, navigational = true)

In one embodiment, a navigational relationship declaration may include a direction attribute. Relationship navigation between entities may be unidirectional or bidirectional. A unidirectional relationship may be traversable from a given entity (i.e., a node) to the target entity (i.e., another node), but it may not be traversable in the other direction (originating from the target entity). An example of a unidirectional relationship may be “reporting” between an employee and a manager, which may be a one-to-one (1:1) or one-to-many (1:n) relationship. The employee may report to the manager, but the manager does not report to the employee and may instead report to a more senior manager or company executive. A “reporting” relationship attribute may thus be designated as unidirectional to indicate a hierarchical structure or directed flow.

A bidirectional relationship, in contrast, may be traversable from either entity in the relationship (i.e., originating from either node on either side of an edge). An example of a bidirectional relationship may be “peers” relating employees to other employees, which may be a many-to-many (n:m) relationship. A first employee may be considered a peer of a second employee, and the second employee may likewise be considered a peer of the first employee. The default value for the direction attribute of navigational relationships may be unidirectional for embodiments with typically hierarchical relationships. For example, the following computer code shows an exemplary navigational relationship declaration with a direction attribute designated as unidirectional.

@RelationshipDefinition (ownership = false, instanceName =

“Category”, navigational = true, direction = unidirectional)

A navigational relationship declaration may also include a visibility attribute. The visibility of a relationship may relate to the programming interface and the actual implementation of the database software. At least one entity in a relationship may have a field or attribute that defines the relationship and identifies the other entity (or entities) in the relationship. For relationships with visibility from both (or multiple) participating entities, an “inverse” attribute may be included in the navigational relationship declaration of certain entities to identify the other entity (or entities) in the relationship. In other words, an inverse relationship between two entities may be supported when there is visibility from both participating entities (or from several participating entities).

While a direction attribute may contextually define the navigational direction—indicating, for example, a hierarchical relationship or directed flow between entities—a visibility attribute may define the programming interface associated with the relationship. For a unidirectional relationship, the source entity may have visibility of the relationship while the target entity may not—both the relationship itself and the target entity may be visible from the source entity, whereas the relationship and/or the source entity may not be apparent from the target entity. In contrast, for a bidirectional relationship, the visibility property could be either a single-sided or an inverse (multi-sided) relationship. In some instances, the direction attribute and the visibility attribute may be congruent, but defining them as separate attributes distinguishes the logical description of direction from the navigational constraints of visibility, and thereby enhances the flexibility and customizability of the database.

For example, in a database with products and prices, the relationship between a particular product and the corresponding price might be defined as bidirectional. However, because finding a particular product given a particular price may be deemed uninteresting, the visibility may be limited to single-sided visibility from the product side of the relationship. In other words, given a particular product, a query or database program could identify the corresponding price of the product, but not the other way around. The relational model may thus be designated as bidirectional while the programming model may be unidirectional or single-sided with limited visibility.

The default value of the visibility attribute may be single-sided. In one embodiment, where there is an inverse (multi-sided) relationship, an “inverse” attribute may be declared to both indicate an inverse relationship and to relate the entities from both sides by identifying the relationship from the perspective of the other entity. As illustrated in FIG. 3B, for example, navigational relationships 306 may relate entity 300 to entities 302 and 304 with an inverse relationship: from the perspective of entities 302 and 304, navigational relationships 306 may have a name attribute of “Products,” whereas navigational relationships 306 may have a name attribute of “Category” from the perspective of entity 300. In the illustrated example, for “outerwear” category entity 302, navigational relationship 306 may associate product entities that correspond to the outerwear category (e.g., included “Products”), including “coat” product entity 300. In the inverse of that relationship, for “coat” product entity 300, navigational relationship 306 may associate category entities that correspond to categories of which “coat” is a part (e.g., a parent “Category”), including “outerwear” category entity 302.

The following computer code shows an exemplary navigational relationship declaration that may correspond to the example illustrated in FIG. 3B with an inverse relationship. The navigational relationship declaration may relate to an entity of type “product” (e.g., “coat” product entity 300). The relationship may define a category of which the product is a part (e.g., outerwear, clothing, etc.) and may be named “Category” from the perspective of the product entity. On the other side of the relationship may be an entity of type “category” (e.g., “outerwear” category entity 302). From the perspective of the category entity, the relationship may be one of products that belong to the category and may be named “Products” accordingly. As seen below, from the perspective of the product entity, the relationship may be named “Category” while the inverse attribute may be designated “Products” corresponding to the relationship from the perspective of the category entity.

@RelationshipDefinition (ownership = false, instanceName =

“Category”, navigational = true, direction = bidirectional,
inverse = “Products”)

A navigational relationship declaration may also include a scope attribute. The scope of the relationship may define the collection of entities that constitute valid entities of either side of the entity relationship. In some instances, the scope constraint may be defined upon instantiation of the persistent collection. The scope attribute may be particularly useful where multiple collections of the same type are present, but entities of only one or a select few of those collections are appropriate for the particular relationship. For example, the following two computer code segments show exemplary navigational relationship declarations with a scope attribute defined to limit the allowable entities on the other side of the relationship. Both declared relationships are directed at entities of type “category,” but the first example is limited to a collection of product categories (e.g., categories based on product characteristics) while the second example is limited to a collection of site categories (e.g., categories based on product sites or locations).

@RelationshipDefinition (ownership = false, instanceName =

“Category”, navigational = true, direction = bidirectional,
inverse = “Products”, scope = “ProductCategory”)

@RelationshipDefinition (ownership = false, instanceName =

“LocationCategory”, navigational = true, direction =
bidirectional, inverse = “Products”, scope = “SiteCategory”)

The scope attribute may thus be used to differentiate among different collections and designate the collections that include entities that are appropriate for the particular relationship.

A navigational relationship declaration may also include a cardinality attribute. The cardinality attribute may constrain the type of relationship that is supported (e.g., 1:1, 1:n, or n:m) or similarly the minimum or maximum number of instances of the relationship that are allowable for given entities. The cardinality may typically be captured and constrained for the side of a relationship that includes a collection (the side where multiple instances of the relationship may typically exist). A cardinality attribute with a value of “1:1” (one-to-one) may indicate that both the entity of interest and the other entity in the relationship may each only have the one relationship of that type. In other words, the same relationship may exist between two different entities, but the relationships cannot mix. For example, in a database with product rankings, each product entity may have a ranking relationship with a ranking position entity, but the product related to the first ranking position cannot also be the product related to the second ranking position, and likewise the first ranking position can be related only to the first-ranked product and no other. In such an example, as rankings change, it may be desired to ensure consistent associations among product entities and ranking entities by restricting navigational relationships with cardinality attributes. A cardinality attribute may thus be used to restrict navigational relationships in order to, for example, maintain logically consistent relationships among entities.

A cardinality attribute with a value of “1:n” (one-to-many) may indicate that the entity of interest may have multiple relationships of the same type with multiple other entities, but a different entity of the same type may not have relationships with those same multiple other entities. For example, a manager-to-employee supervisory relationship may be limited with a cardinality of “1:n” to indicate that the manager may supervise many employees (and have many manager-to-employee supervisory relationships), but those employees do not have other managers of the same type (the employees each have only the one employee-to-manager supervisory relationship).

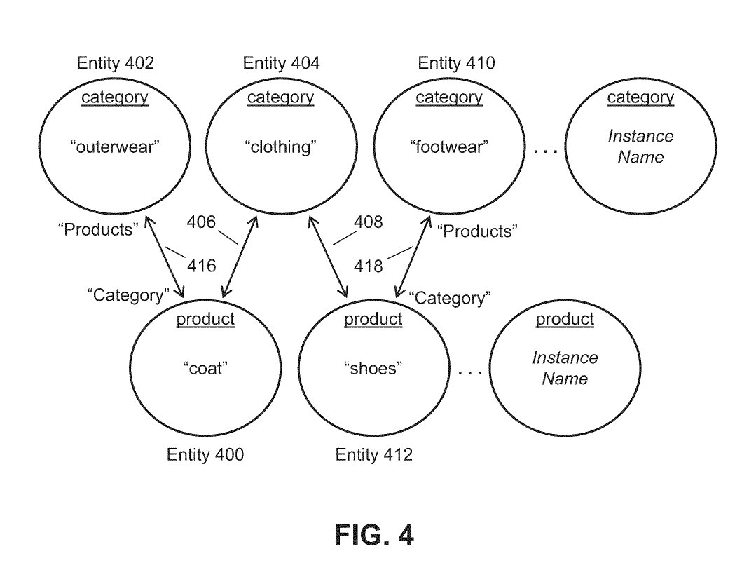

In contrast, a cardinality attribute with a value of “n:m” (many-to-many) may indicate that the entity of interest may have multiple relationships with multiple other entities that are the same type, and a different entity of the same type may also have relationships with those same multiple other entities. For example, in a database of product entities related to multiple category entities, a product may belong to multiple categories, and another product may belong to some or all of the same multiple categories (e.g., a pair of shoes may belong to a clothing category and a footwear category, and a coat may belong to the same clothing category but also an outerwear category). For example, as illustrated in FIG. 4, product entities 400 and 412 may have navigational relationships 406 and 408, respectively, which associate both product entities with category entity 404. Product entity 400, however, may also have navigational relationship 416 associating it with category entity 402, and product entity 412 may have navigational relationship 418 associating it with category entity 410. Thus, as illustrated, with an “n:m” or many-to-many cardinality, multiple entities of the same type may have relationships with multiple other entities that share the same type. The following computer code shows an exemplary navigational relationship declaration that may correspond to any of navigational relationships 406, 408, 416, or 418 of FIG. 4, including a cardinality attribute with a value of “n:m.”

@RelationshipDefinition (ownership = false, instanceName =

“Category”, navigational = true, direction = bidirectional,
inverse = “Products”, cardinality = “n:m”)

A navigational relationship declaration may also include constraints on the minimum and/or maximum number of a particular relationship for a given entity. The attributes may be referred to as “min” and “max” and may have values of zero or any positive whole number. The default values of the min and max attributes may be zero and infinity, respectively. For example, in a database of product entities that relate to category entities, the minimum number of category relationships may be constrained to one (1) to indicate that each product may belong to at least one category. On the other hand, in a database of employee entities and office resource entities (e.g., offices, desks, workstations, etc.), the maximum number of employee/office resource relationships may be constrained to one (1) to indicate that each employee may occupy at most one office resource. The following computer code shows an exemplary navigational relationship declaration for product entities related to category entities, where the minimum number of relationships is one and the maximum number of relationships is ten, thereby constraining each product entity to have at least one category relationship and at most ten category relationships.

@RelationshipDefinition (ownership = false, instanceName =

“Category”, navigational = true, direction = bidirectional,
inverse = “Products”, scope = “ProductCategory”, min = 1, max =
10)

A navigational relationship declaration may also include support for attribute filters that may be used in queries. By including certain attribute filters in the navigational relationship declaration, a query over the graph index may be more efficient, may be more accurate, may allow a query to be completed without necessitating access to the underlying entity store for particular attribute filters, or may provide various other benefits. Navigational queries in particular may support predicates or filters on the properties of the entities being traversed in a relational store, such as a graph database. To support such filtering on entity properties, the underlying entity may be accessed in the relational store to fetch and evaluate the filters based on entity attributes. In some embodiments, however, the filters and attributes may be replicated in both the graph index (the navigational store) and the underlying entity store (the relational store or typical underlying database). By replicating the attributes and filters in the graph index, the overhead of accessing the underlying entity store may be avoided. Thus, in some embodiments, a database developer may be able to define the set of properties, attributes, filters, and the like that are most likely to be used in queries and may, therefore, beneficially be replicated and/or indexed in the graph index to reduce data access costs.

Entity filters may include constraints on attribute values as well as binary expressions using operators such as AND, OR, NOT, and the like. Additional constraints on the type of entity may also be implemented. In one embodiment, a “typeof( )” constraint and a “typeof(only)” constraint may be implemented. The typeof( ) operator may refer inclusively to the type of an entity and also all of its derived types (i.e., all types that are derived from the specified type and inherit its features). In contrast, the typeof(only) operator may refer exclusively to the specified type and exclude any derived types. For example, in an employee database, a defined “person” type may be used to spawn several derived types such as a “manager” type and an “individualContributor” type. Manager entities and individualContributor entities may all include the features of a person entity in addition to any unique features of the derived types. In a query that constrains results to typeof(person), the database system (or database graph) may return true for any person, manager, or individualContributor entities (or any other derived types of person). In a query that constrains results to typeof(only, person), however, the database system may return true for only entities of type person (excluding any derived types of person).

As mentioned above, a defined type may be used to spawn another defined type through inheritance. Such inheritance may provide support for polymorphic collections. The support may be explicit through the use of an under clause (or sub-table), or it may be implicit through the use of the same collection name in the declaration of multiple different collections of the same type as the original collection, or multiple collections that include types derived from the type of the original collection. The query mechanism may be able to filter based on entity type using the typeof( ) operators discussed above, thereby enabling the user to filter on attributes that are defined either in the specified type or in a type derived from the root type. Whether or not the target collection is polymorphic, the data model may make it possible to override the set of indexed properties (attributes) to add additional attributes from the derived types to further customize the database and enhance efficiency of anticipated queries on derived types.

Navigational relationships in polymorphic collections of derived entities may be further refined by constraining entity relationships. For example, the following computer code shows an exemplary navigational relationship declaration that assigns a value of “ExternalProductCategory” to a typeof attribute of a “Category” relationship. The “Category” relationship may thereby be restricted in scope to defining entity relationships with entities that are part of a collection named ExternalProductCategory. By including these details in the navigational relationship itself, subsequent queries on the relationships in the database may be made more efficient, and the costs of accessing the underlying entity database may be reduced or eliminated (e.g., memory access delay, resource occupation, etc.).

@RelationshipDefinition (ownership = false, instanceName =

“Category”, navigational = true, direction = bidirectional,
inverse = “Products”, scope = “ExternalProductCategory”, min =
1, max = 10, typeof = ExternalProductCategory)

As mentioned above, the graph index may include replicated and/or indexed attributes that are associated with entities in the underlying database (e.g., in the underlying relational store or graph database). By replicating or indexing this data, filtering overhead may be reduced, particularly when managing data across different repositories. A navigational relationship declaration may include an “indexed” attribute for defining entity attributes that should be indexed for improved access. For example, the following computer code shows an exemplary navigational relationship declaration with an indexed attribute with values of name and createdDate. This may signify that for that entity relationship, the name attribute and createdDate attribute should be indexed for improved accessibility.

@RelationshipDefinition (ownership = false, instanceName =

“Category”, navigational = true, direction = bidirectional,
inverse = “Products”, scope = “ProductCategory”, indexed =
{name,createdDate})

With a graph index created, a variety of different query approaches and runtime optimizations may be made available to users. A query may be executed following some or all of the steps of process 200 described above, although many variations are possible. In effect, there may be two or more databases upon which a query may be processed (e.g., graph index store 102 and one or more of relational stores 104), which may both lead to opportunities for optimization and introduce tradeoffs. In some embodiments, a single database may be stored in a single physical repository or across multiple physical repositories. Likewise, multiple databases may be stored on the same physical repository or on multiple physical repositories. A first database may be the underlying entity database that may be a typical relational store as discussed above. The second database may be the graph index (or navigational store) discussed herein for improving querying (e.g., improving querying on entity relationships). One query approach may be computing the interaction of the two databases. For example, a query may be executed on each database separately, and the results of each may be compared, combined, or the like to provide a comprehensive result set. In some embodiments, a query on the relational database and a query on the graph index may be computed simultaneously, thereby improving performance by running the queries in parallel to obtain each result set for comparison, combination, or the like.

In another query approach, a query may be executed on the graph index (or navigational store) first, which may, for example, yield a result set that identifies a particular subset of the underlying relational database. A query on the underlying relational database may then be executed solely on the subset identified by the graph index query. The first query of the navigational store may be a query of the navigational components of the underlying entities or objects, while the second query may be a query of the associative parts of each navigated object. Being able to separately query each database in sequence may offer improved query options for users, and may also result in improved query performance. For example, running a query on the entire underlying relational database may be time-expensive. Running a query on the graph index, in contrast, may be quicker and more efficient in some cases. Using a query on the graph index to narrow the query on the underlying relational database to a subset of the database may thus improve overall query performance, leveraging a potentially faster query to reduce the scope of a potentially more time-expensive query.

In still another query approach, the associative component of a query may be computed first on the underlying relational database, and the navigational component of a query may be computed second on the graph index (navigational store). For some queries, it may be more efficient to narrow a query on the navigational store by first identifying a subset of the store based on a query of the underlying database. In other words, a query on the underlying relational database based on associative components or particular attributes may efficiently narrow a subsequent query on the graph index such that the overall query performance is improved. Such an approach may also produce a result set that more closely matches the needs of a particular user. For example, when the navigational components or entity relationship attributes form a part of the desired result set, this approach of narrowing first on associative entity attributes and subsequently on navigational components may produce the desired results more efficiently than other approaches, particularly over a query of only the underlying relational database.

Thus, a variety of query approaches may be available for database users, and other approaches utilizing the graph index may be readily apparent to those of ordinary skill in the art. Moreover, users may elect a query approach or a combination of approaches based on a variety of factors, such as the desired result set, the relative sizes of the relational database and graph index, the relative query costs of the relational database and graph index, capacity for simultaneously running multiple queries on different databases, and the like.

In addition to optimizing query evaluation by leveraging the graph index, other runtime optimizations may also be available. For example, metadata about cardinality and the cost of processing each database may be used to optimize query performance or to aid users in selecting a particular query approach. In some instances, a relational database may require significantly more or significantly less computation time to process a particular query. In some embodiments, the relative processing costs may be used to automatically select which query to process first or to direct where optimization efforts may have the greatest impact. Similarly, metadata about cardinality may be used to optimize queries and select (in some cases automatically) a particular query approach.

Another optimization opportunity may be in tracking how each database is used with particular queries, which may be used to modify the databases or query approaches to improve performance. For example, commonly used queries of each database may be stored and analyzed to determine how performance may be improved in a particular instance. Database access patterns may also be tracked to adapt the storage to the needs of particular users or a particular organization. For instance, if certain attributes are routinely accessed from the underlying relational database, those attributes may be added as indexed attributes in the graph index to improve access times. Similarly, if certain queries are repeated, those queries may be retained and used to provide future query results (i.e., return the last result when no database changes have been recorded, return a combination of the last result and any incremental database changes, etc.). Thus, various optimizations may be implemented for use with, for example, a relational database and a graph index, and still further optimizations may be implemented at runtime based, for example, on database usage.

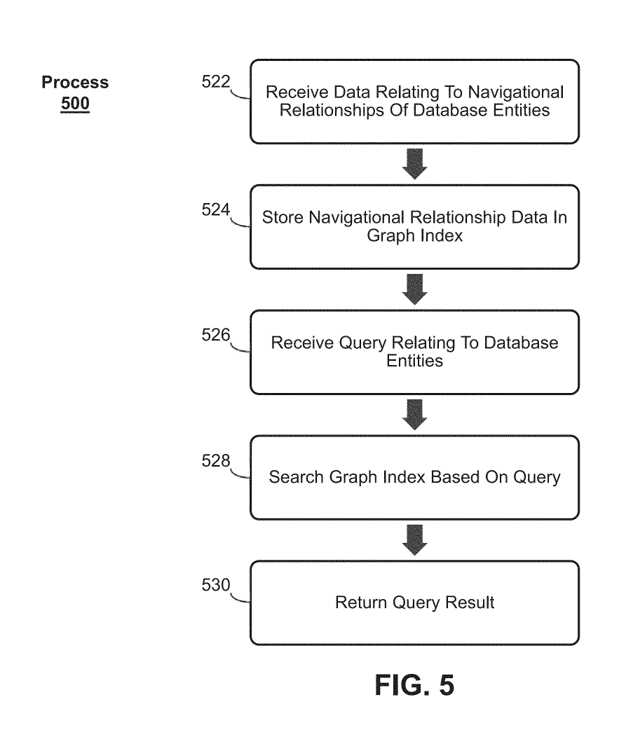

FIG. 5 illustrates exemplary process 500 for managing graph queries on navigational relationships of database entities. At block 522, data relating to navigational relationships of database entities may be received. Navigational relationship data may include any of the attributes discussed herein defining relationships between database entities (e.g., direction, visibility, scope, cardinality, etc.). At block 524, the navigational relationship data may be stored in a graph index. A graph index may be formatted as a graph database to enable navigational queries. At block 526, a query relating to entities in the database may be received. A query may seek any of a variety of information and may include navigational components. At block 528, the graph index may be searched based on the query. In one embodiment, the graph index may be searched at the same time as the database. In other embodiments, the graph index may be searched before searching the database, or the database may be searched before searching the graph index. At block 530, the query results may be returned.

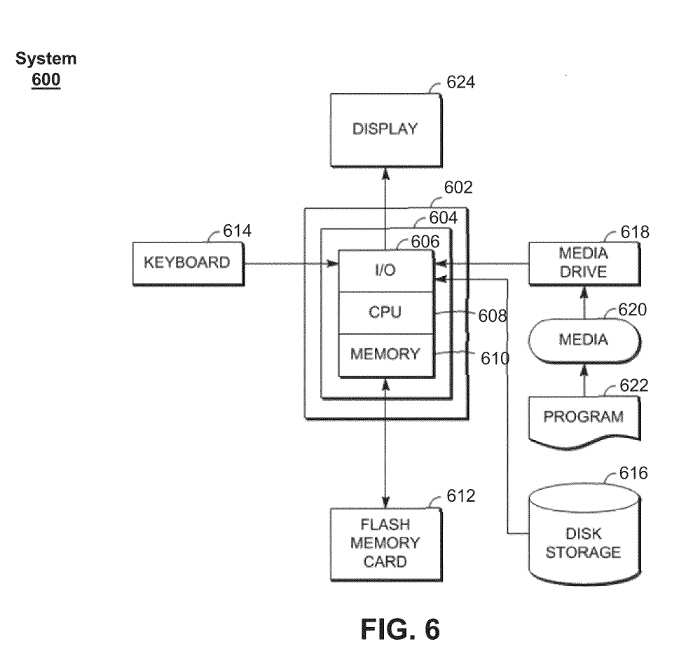

FIG. 6 depicts an exemplary computing system 600 configured to perform any one of the above-described processes. In this context, computing system 600 may include, for example, a processor, memory, storage, and input/output devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 6 depicts computing system 600 with a number of components that may be used to perform the above-described processes. The main system 602 includes a motherboard 604 having an input/output (“I/O”) section 606, one or more central processing units (“CPU”) 608, and a memory section 610, which may have a flash memory card 612 related to it. The I/O section 606 is connected to a display 624, a keyboard 614, a disk storage unit 616, and a media drive unit 618. The media drive unit 618 can read/write a computer-readable medium 620, which can contain programs 622 and/or data.

At least some values based on the results of the above-described processes can be saved for subsequent use. Additionally, a non-transitory computer-readable medium can be used to store (e.g., tangibly embody) one or more computer programs for performing any one of the above-described processes by means of a computer. The computer program may be written, for example, in a general-purpose programming language (e.g., Pascal, C, C++, Java) or some specialized application-specific language.

Various exemplary embodiments are described herein. Reference is made to these examples in a non-limiting sense. They are provided to illustrate more broadly applicable aspects of the disclosed technology. Various changes may be made and equivalents may be substituted without departing from the true spirit and scope of the various embodiments. In addition, many modifications may be made to adapt a particular situation, material, composition of matter, process, process act(s) or step(s) to the objective(s), spirit or scope of the various embodiments. Further, as will be appreciated by those with skill in the art, each of the individual variations described and illustrated herein has discrete components and features that may be readily separated from or combined with the features of any of the other several embodiments without departing from the scope or spirit of the various embodiments. All such modifications are intended to be within the scope of claims associated with this disclosure.

What is claimed is:

1. A computer-implemented method for managing graph queries on navigational relationships of database entities, the method comprising:
receiving a query relating to entities of a database;
causing, by a processor, a graph index to be searched based on the query, wherein the graph index comprises data relating to navigational relationships of entities of the database; and
returning a result of the query;
wherein the navigational relationship data comprises statically-defined entity relationship data and dynamically-defined entity relationship data.

2. The computer-implemented method of claim 1, wherein searching the graph index comprises navigating the graph index to retrieve navigational relationship data.

3. The computer-implemented method of claim 1, wherein the database comprises an object relational database.

4. The computer-implemented method of claim 1, wherein the navigational relationship data comprises a direction attribute that indicates relationship direction between database entities.

5. The computer-implemented method of claim 1, wherein the navigational relationship data comprises a visibility attribute that indicates relationship visibility between entities.

6. The computer-implemented method of claim 1, wherein the navigational relationship data comprises a scope attribute that designates valid entities on a side of an entity relationship.

7. The computer-implemented method of claim 1, wherein the navigational relationship data comprises a minimum attribute or a maximum attribute that constrains a number of relationships for an entity.

8. The computer-implemented method of claim 1, wherein the graph index comprises at least one entity attribute replicated from an entity in the database.

9. The computer-implemented method of claim 1, further comprising:
searching the database based on the query.

10. The computer-implemented method of claim 9, wherein results of the graph index search are used to narrow the database search.

11. The computer-implemented method of claim 9, wherein results of the database search are used to narrow the graph index search.

12. The computer-implemented method of claim 1, further comprising:
causing data to be stored relating to a prior query; and
generating a query execution plan based on the stored query data;
wherein the graph index search is based on the generated query execution plan.

13. A non-transitory computer-readable storage medium comprising computer-executable instructions for managing graph queries on navigational relationships of database entities, the instructions comprising:
receiving a query relating to entities of a database;
causing, by a processor, a graph index to be searched based on the query, wherein the graph index comprises data relating to navigational relationships of entities of the database; and
returning a result of the query;
wherein the navigational relationship data comprises statically-defined entity relationship data and dynamically-defined entity relationship data.

14. The computer-readable storage medium of claim 13, wherein searching the graph index comprises navigating the graph index to retrieve navigational relationship data.

15. The computer-readable storage medium of claim 13, wherein the graph index comprises at least one entity attribute replicated from an entity in the database.

16. The computer-readable storage medium of claim 13, the instructions further comprising:
searching the database based on the query.

17. The computer-readable storage medium of claim 16, wherein results of the graph index search are used to narrow the database search.

18. The computer-readable storage medium of claim 16, wherein results of the database search are used to narrow the graph index search.

19. The computer-readable storage medium of claim 13, the instructions further comprising:
causing data to be stored relating to a prior query; and
generating a query execution plan based on the stored query data;
wherein the graph index search is based on the generated query execution plan.

20. A system for managing graph queries on navigational relationships of database entities, the system comprising:
a memory comprising a database; and
a processor configured to:
receive a query relating to entities of a database;
cause a graph index to be searched based on the query, wherein the graph index comprises data relating to navigational relationships of entities of the database; and
return a result of the query;
wherein the navigational relationship data comprises statically-defined entity relationship data and dynamically-defined entity relationship data.

21. The system of claim 20, wherein searching the graph index comprises navigating the graph index to retrieve navigational relationship data.

22. The system of claim 20, wherein the graph index comprises at least one entity attribute replicated from an entity in the database.

23. The system of claim 20, the processor further configured to:
search the database based on the query.

24. The system of claim 23, wherein results of the graph index search are used to narrow the database search.

25. The system of claim 23, wherein results of the database search are used to narrow the graph index search.

26. The system of claim 20, the processor further configured to:
cause data to be stored relating to a prior query; and
generate a query execution plan based on the stored query data;
wherein the graph index search is based on the generated query execution plan.
